(19) United States
(12) Patent Application Publication
(10) Pub. No.: US 2005/0021712 A1
(43) Pub. Date: Jan. 27, 2005

(54) Multi-user, multi-device remote access system

(76) Inventors: Constantin Chassapis, Upper Saddle River, NJ (US); Sven K. Esche, Hoboken, NJ (US); Jan W. Nazalewicz, Mahwah, NJ (US); Dennis J. Hromin, Ridgefield, NJ (US)

Correspondence Address: Wolff & Samson PC, One Boland Drive, West Orange, NJ, 07052, US

(21) Appl. No.: 10/764,137

(22) Filed: Jan. 23, 2004

Related U.S. Application Data
(60) Provisional application No. 60/442,637, filed on Jan. 24, 2003.

(51) Int. Cl. G06F 15/173

(52) U.S. Cl. 709/223

(57) ABSTRACT

A multi-user, multi-device remote access system is provided for allowing a plurality of non-homogenous, spatially-distributed devices, such as sensors, actuators, controllers, and other similar devices, to be remotely controlled by a user via a user interface. A universal controller allows devices of various types to be automatically integrated therewith for use. The universal controller communicates with a resource manager that monitors and dispatches requests for information and commands generated by the user at the user interface. High-level instructions are entered by a user at the user interface, received by the resource manager, and translated into bytecodes, whereupon the bytecodes are sent to an appropriate universal controller based upon instruction type and device availability. The bytecodes are executed by the universal controller, and one or more devices connected therewith are activated. Results of execution are gathered by the universal controller, transmitted to the resource manager, and dispatched to the user interface for display to the user. System status information is provided by the resource manager and accessible via the user interface.

### RELATED APPLICATIONS

This application claims the priority of Provisional Patent Application Ser. No. 60/442,637, filed Jan. 24, 2003, the entire disclosure of which is expressly incorporated herein by reference.

### BACKGROUND OF THE INVENTION

1. Field of the Invention

The present invention relates to a multi-user, multi-device remote access system. More specifically, the invention relates to a remote access system for networking a plurality of spatially-distributed, non-homogenous devices, including sensors, actuators, controllers, and other similar devices, via a universal and reconfigurable architecture.

2. Related Art

Advances in computing power, in conjunction with declining costs of communications equipment, have lead to a drastic increase in the capabilities of computer networks. Concomitantly, there has been a rapid increase in the types and numbers of devices connected to such networks. For example, the Internet has experienced a significant increase in the number of connected nodes. Such nodes predominantly comprise client and server computer systems, but also include other types of devices, such as web-enabled and wireless devices (e.g., web cameras, cellular telephones, and alphanumeric pagers).

In addition to increases in the size and power of such networks, there has also been a noticeable increase in the amount of network-enabled devices. For example, various systems have been implemented, such as the Supervisory Control and Data Acquisition (SCADA) system, and other factory automation systems which allow data from various sensors to be culled at a central location and made accessible via a network (e.g., LAN, WAN, intranet, or the Internet). A particular problem with existing systems is that the sensors and actuators connected therewith are of a similar type (e.g., electromechanical, optical, or acoustic), and it is difficult to integrate a plurality of sensors and actuators of various types into a single architecture. Moreover, such systems are not easily reconfigurable such that sensors of various types can be connected to the network, integrated therewith, and utilized without requiring the network to be brought down and/or system software to be reconfigured. Further, sensors and actuators of various types cannot easily be configured to interact or operate together without being programmed to do so.

Accordingly, what is needed, but has not heretofore been provided, is a multi-user, multi-device remote access system that is dynamically reconfigurable and allows a plurality of non-homogeneous, spatially-distributed devices, including sensors, actuators, controllers, and other similar devices, to be automatically integrated for use in a common architecture.

### SUMMARY OF THE INVENTION

The present invention relates to a multi-user, multi-device remote access system. A reconfigurable architecture is provided for allowing a plurality of sensors, actuators, controllers, and other similar devices to be automatically integrated and dynamically configured for use within a common network or architecture. The invention comprises at least one user access device, such as a laptop computer, a desk top computer, or a Personal Digital System (PDA), a resource manager connected to the user access device via a network connection, a universal controller connected to the resource manager via a network connection, and a plurality of devices, including sensors, actuators, and controllers, connected to the universal controller. A plurality of such sensors and actuators can be connected to a single universal controller, and more than one universal controller can be provided. The resource manager of the present invention handles control commands and requests for information provided at the user access device, processes same, and selectively distributes the commands and requests for information to an appropriate universal controller based upon the type of instruction and the types and availabilities of devices connected to the universal controller. The universal controller then dispatches the command or request for information to a particular sensor, executes the command or processes the request for information, and provides responsive data to the resource manager. The resource manager then dispatches the received response to the user access device for display to and review by a user.

In an embodiment of the present invention, a resource manager that resides on a network server is provided. A user can input one or more high-level instructions using a user interface, and the instructions are sent to the resource manager of the present invention. A compiler at the resource manager converts the instructions into bytecodes. The bytecodes are then dispatched to one or more universal controllers. The universal controller receives bytecodes from the resource manager, decodes and executes the bytecodes, activating one or more of the devices connected thereto. The universal controller monitors the devices for responses and transmits same to the resource manager. The resource manager then transmits the results to the user access device, wherein the results are displayed on the user access device.

The resource manager of the present invention provides process scheduling and management functionality for the universal controllers. Additionally, the universal controllers provide status information as to each of the devices connected therewith, and transmit the status information to the resource manager. The status information can then be dispatched to the user access device in response to a request for information.

### BRIEF DESCRIPTION OF THE DRAWINGS

These and other important objects and features of the invention will be apparent from the following Detailed Description of the Invention, taken in connection with the accompanying drawings, in which:

FIG. 1 is a diagram showing the overall system architecture of the present invention.

FIG. 2 is a block diagram showing the universal controller of the present invention in greater detail.

FIG. 3 is a block diagram showing component parts of the universal controller in greater detail.

FIG. 4 is a block diagram showing interactions between the universal controller, expansion modules, resource manager, and client application of the present invention.

FIG. 5 is a block diagram showing an embodiment of the universal controller and expansion module of the present invention.

FIG. 6 is a block diagram showing processing sequences for handling instructions generated by a user and results generated by an access device.

FIG. 7a is a flowchart showing processing logic of the universal controller of the present invention.

FIG. 7b is a flowchart showing processing logic of the expansion module of the present invention.

FIG. 8 is a block diagram showing component parts of the user interface of the present invention.

FIG. 9 is a block diagram showing processing logic of the resource manager of the present invention.

FIG. 10 is a flowchart showing additional processing logic of the resource manager of the present invention.

FIG. 11a is a block diagram showing processing logic of the compiler of the present invention.

FIG. 11b is a diagram showing compilation of a series of high-level instructions into bytecodes executable by the universal controller of the present invention.

FIG. 12 is a block diagram showing a video capture device in accordance with the present invention.

FIG. 13 is a diagram showing interactions between the user interface and resource manager of the present invention, and one or more smart clients.

FIG. 14 is a block diagram showing a packet structure according to the present invention for transmitting control commands to a module.

FIG. 15 is a block diagram showing a packet structure according to the present invention for transmitting an event from a module.

FIG. 16 is a block diagram showing a packet structure according to the present invention for transmitting data between the universal controller of the present invention and an expansion module.

FIG. 17 is a block diagram showing a packet structure according to the present invention for transmitting error codes.

FIG. 18 is a block diagram showing a packet structure for transmitting data between the resource manager of the present invention and a universal controller.

FIG. 19 is a block diagram showing another packet structure for transmitting data between the universal controller of the present invention and an expansion module.

### DETAILED DESCRIPTION OF THE INVENTION

The present invention relates to multi-user, multi-device remote access system. A plurality of non-homogenous, spatially-distributed devices, such as sensors, actuators, controllers, and other similar devices, can be remotely controlled by a user interacting with a user interface. The devices are connected to a universal controller that allows devices of various types to be automatically integrated therewith for use. The universal controller communicates with a resource manager that monitors and dispatches requests for information and commands generated by the user at the user interface. High-level instructions are received at the user interface, and sent to the resource manager. A compiler translates the high-level instructions into bytecodes. The resource manager dispatches the bytecodes to an appropriate universal controller. The universal controller decodes the bytecode into instructions and executes same using one or more devices connected therewith. Results of execution are gathered by the universal controller and transmitted to the resource manager, whereupon the data is dispatched to the user interface and displayed to the user. A library of common instructions is provided, and can be selected from and executed by the user.

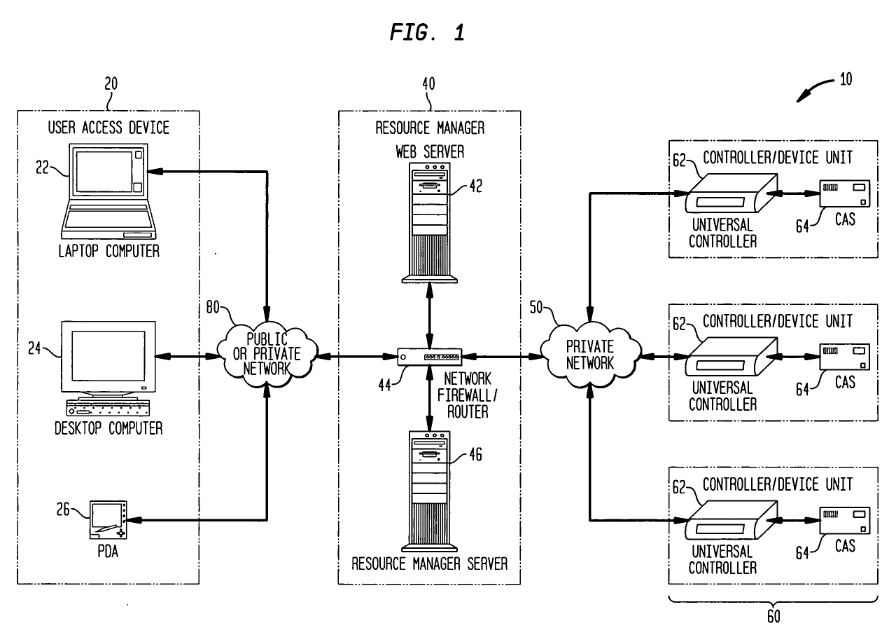

FIG. 1 is a diagram showing the overall system architecture of the present invention, indicated generally at 10. The architecture 10 allows users to interact with a wide range of distributed sensing and actuating resources, and comprises a user access device 20, a resource manager 40, and controller/device units 60. The user access device 20 is connected via a public or private network connection 30 to the resource manager 40. Such connection may be, for example, a local area network (LAN), wide area network (WAN), campus area network (CAN), intranet, or the Internet. The resource manager 40 is preferably connected to the controller/device units 60 via a private network (e.g., a LAN), but a public network connection could also be used.

The user access device 20 can be embodied in any available computer system known in the art and having a graphical user interface. For example, a laptop computer 22 running the WINDOWS operating system (or other similar OS) could be provided. Also, a desktop computer 24 could be provided, as well as a personal digital assistant (PDA) 26. Each of these devices preferably has a JAVA-enabled web browser for receiving and dispatching high-level instructions, as will hereinafter be discussed in greater detail. Also, each of these access devices preferably includes a network interface (wired or wireless) for allowing connection to the network 30. The user access device 20 allows a user to manually enter high-level instructions for controlling and/or acquiring data from one or more remote sensors, actuators, or controllers, and to retrieve and manipulate general, instanced, or sequenced instructions from a library.

Importantly, the user access device 20 provides a variety of functionality. The main functions of the user access device 20 include, but are not limited to: the input and output of high-level user data by means of a wired or wireless network connection; assembling the high-level user inputs and outputs into sequences of instructions; communicating the instructions to the resource manager 40; communicating system response data from the resource manager 40; analyzing system response data and conversion of such data into user-understandable formats; and storing general instructions, instanced instructions, and instruction sequences that are repeatable (e.g., executed more than once) in a library.

Preferably, software modules executable by the user access device 20 are stored at and executed from the resource manager 40, but could be permanently installed on the user access device 20. Further, the software modules could be downloaded from the resource manager 40 (e.g., in the form of JAVA applets) for each individual task performed by the user, thus minimizing server load and bandwidth requirements. Such modules, once downloaded and executed by the user access device 20, could be deleted therefrom to conserve storage space.

The resource manager 40 includes a network server 42 and a resource manager server 46 networked together and connected to the networks 30 and 50 via a network firewall or router 44. The resource manager server 46 receives instructions from the user access device 20, compiles the instructions into bytecodes, and selectively dispatches the bytecodes to one or more of the controller/device units 60 for execution thereby. Further, the resource manager server 46 receives results and status information from the controller/device units 60, and selectively transmits same to the user access device. The network server 42 provides a web-based graphical user interface that is displayed on the user access device 20, and which allows the user to remotely interact with one or more of the controller/device units 60. Additionally, the resource manager server 46 includes a library of frequently executed instructions. Such instructions are in the form of general, instanced, or sequenced instructions, but other instruction formats are considered within the spirit and scope of the present invention.

The resource manager 40 organizes interactions between multiple users and multiple devices through network interface standards. The functionality provided by the resource manager 40 includes, but is not limited to: user task generation; task scheduling, routing, controlling and monitoring; the determination of current sensor and actuator configurations; device availability and communications channel tracking; system fault detection and resolution; and self-configuration in the case of system expansion.

The resource manager 40 monitors initial system status information (e.g., status information occurring during system installation, expansion, or re-configuration), repeated system status information (e.g., status information occurring at scheduled intervals or pre-determined times), and constant system status information. Examples of status information include, but are not limited to: current system configuration information (e.g., the existence of system components); topology (e.g., structure of system components); component interactions; component availability (e.g., functionality, capacity, current usage and availability, and operational readiness); and system loading (e.g., the total number of current system users, percentage of usage of existing communications channel bandwidth, and allowable signal ranges from sensors). Further, the resource manager 40 can schedule tasks for execution in a user-transparent fashion. In this arrangement, the resource manager 40 selects a device and/or path of information flow between a specific user access device 20 and a specific actuator and/or sensor based upon user-specified requirements and functional specification relating to available system components.

The controller/device units 60 each comprise a universal controller 62 and a combination of sensors and actuators 64. The universal controller 62, as will be discussed in greater detail below, comprises a microprocessor for receiving bytecodes from the resource manager 40, converting same into one or more instructions, and executing the instructions using one or more of the sensors and actuators 64. Further, the universal controller 62 comprises circuitry for interfacing with a variety of non-homogenous actuators and sensors that comprise the sensors and actuators 64. For example, the sensors and actuators 64 could comprise electromechanical, optical, acoustic, seismic, magnetic, moisture, pollution, organic, pressure, acceleration, physiological, thermal, and other types of sensors, as well as electric motors, pneumatic, hydraulic, and electromagnetic drives, pumps, valves, fans, relays, switches, and other types of actuators, each of which communicates with the universal controller 62 via associated circuitry. Further, the universal controller 62 could be interfaced with remote computing equipment, such as servers, workstations, hubs, switches, access points, gateways, and other similar devices where it would be desirable to provide remote access and control.

The universal controller 62 gathers results from the sensors and actuators 64, in addition to status information, and transmits the results to the resource manager 40. The operational readiness of the sensors and actuators 64 can be checked either directly by measuring characteristics such as voltage, current, resistance, capacitance, inductance, temperature, etc., or can be verified indirectly by analyzing the integrity, validity, and plausibility of the generated signals by comparing same to software models or by using knowledge-based approaches.

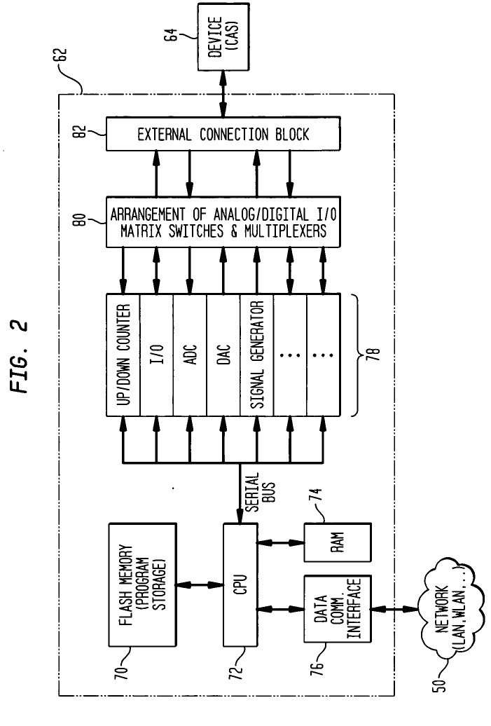

FIG. 2 is a block diagram showing the universal controller 62 of the present invention in greater detail. As was previously discussed, the universal controller 62 communicates via a network connection 50 with the resource manager of the present invention, exchanging bytecodes therewith. Further, as was previously mentioned, the universal controller 62 interacts with sensors and actuators 64, dispatching decoded instructions thereto for execution and culling results of execution therefrom, including status information. The universal controller 62 comprises a central processing unit (CPU) 72, which contains processing logic for performing the aforementioned functionality of the universal controller 62. The CPU 72 is preferably a microprocessor manufactured by RABBIT SEMICONDUCTOR, Inc.

The CPU 72 is provided with a random access memory (RAM) 74 for temporarily storing information. Further, a flash memory 70 (e.g., an EEPROM or other type of non-volatile memory circuit known in the art) is provided for storing program instructions and processing logic for use by the CPU 72. A data communications interface 76 allows the universal controller 62 to communicate with the network 50, so that bytecodes can be exchanged with one or more resource managers of the present invention. The CPU 72 communicates with a plurality of expansion modules 78 via a serial bus internal to the universal controller 62. Bytecodes received from the data communications interface 76 are decoded by the CPU 72, under control of processing logic stored within the flash memory 70, into one or more machine-understandable instructions. The instructions are then dispatched by the CPU 72 to one or more of a plurality of expansion modules 78 for execution thereby.

The expansion modules 78 comprise a variety of disparate circuits for interfacing the universal controller 62 with one or more sensor and actuators 64. The expansion modules 78 allow the sensors and actuators 64 to perform a variety of tasks including, but not limited to: up/down counting; digital inputting/outputting; analog to digital conversion; digital to analog conversion; signal generation; power amplification; and opto-relay switching. A parallel and/or serial arrangement of switching and multiplexing devices 80 allows a multitude of sensors and actuators 64 to establish dynamically re-configurable links with the input/output ports of the expansion modules 78 via an external connection block 82. This allows the routing of both analog and digital signals, and protects the expansion modules 78 from possible overloads. The external connection block 82 comprises terminals for allowing analog and/or digital sensors and/or actuators to be connected therewith.

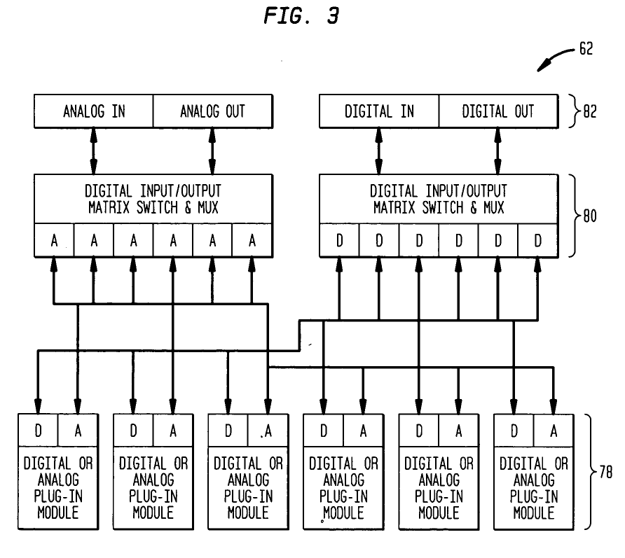

FIG. 3 is a block diagram showing component parts of the universal controller 62 in greater detail. The switching and multiplexing devices 80, mentioned earlier, connect to a plurality of digital or analog input and output ports of the external connection block 82. Digital and analog information received therefrom is selectively switched by the multiplexers 80, and transmitted to a respective digital or analog plug-in module 78. Devices (e.g., additional expansion modules) connected to the universal controller 62 can be detected via interrupts upon connection to the system bus, wherein the universal controller 62 processes the interrupt and identifies the new expansion module.

Importantly, the present invention includes a data communication infrastructure that facilitates the transmission of various types of data between the users and the individual system components. Data communication is preferably based on standard networking methodologies, such as Ethernet, wireless Ethernet, cellular, point-to-point, serial, and parallel methodologies. Data can be transmitted using any suitable network protocol, such as TCP/IP, Bluetooth, USB, IEEE 1394 (Firewire), IEEE 802.11x, RS232, RS488, and IEEE 1284.

The present invention can be implemented in a variety of settings, including educational, industrial, residential, and commercial settings. For example, the present invention could be implemented to provide an intelligent building, wherein sensors and actuators monitor and control a variety of mechanical, thermal, electrical, environmental, and security systems. Such an application would allow for central monitoring and control of equipment throughout a large building, thereby obviating the need for building and maintenance personnel to physically travel to the respective locations of each of the devices to monitor same. Further, such a system could be integrated for remote use by security personnel, allowing 24 hour, 7 days per week security monitoring of facilities.

Further, a flexible manufacturing system could be provided, wherein technical data is gathered and monitored by the present invention, and logistical data is utilized to optimize manufacturing efficiency. This application would provide additional benefits over the aforementioned existing SCADA and factory automation systems, such that not only would remote devices be monitored, but also the overall efficiency of the factory and/or segment thereof could be calculated and devices remotely controlled to optimize such efficiency.

Moreover, the present invention can be applied in the medical field, in smart traffic control systems, intelligent agricultural systems, and flood control systems. For example, traffic lights, switching equipment, and other traffic control systems could be integrated with the present invention, allowing city-wide or regional control of such systems from any desired remote location. Further, large-scale farming operations could be outfitted with the remote access system of the present invention to allow remote monitoring and control of farming and agricultural processes and efficiencies. Any conceivable application is considered within the spirit and scope of the present invention.

Importantly, the present invention can be configured to provide remote laboratory capabilities, as will be discussed hereinafter in greater detail. A plurality of sensors and actuators frequently used in laboratory experiments (e.g., temperature sensors used in thermal experiments, or mechanical actuators used in mechanical engineering curricula and lab experiments), could be integrated together for remote use and monitoring via the remote access system of the present invention. In such an arrangement, students could perform portions of a lab assignment at the laboratory, continue such experiments remotely (e.g., from a computer lab, dorm room having connectivity, or from home), and perform post-experiment calculations and verifications using the student's local computer.

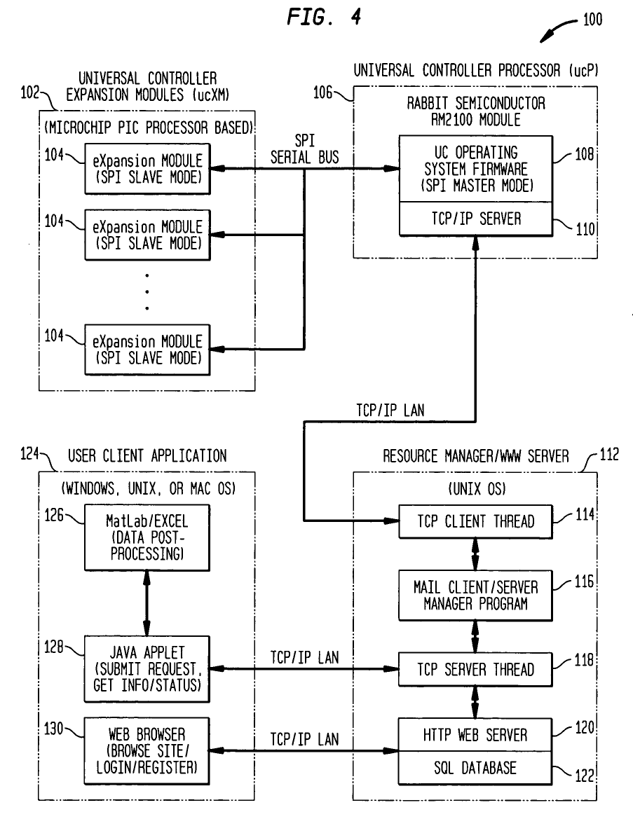

FIG. 4 is a block diagram showing interactions between the universal controller, expansion modules, resource manager, and client application of the present invention, configured for use in a remote laboratory. The laboratory architecture, indicated generally at 100, allows students and faculty to remotely administer, perform, and monitor laboratory experiments. A universal controller processor 106 communicates with a plurality of universal expansion modules 102 via a serial bus connection (e.g., SPI, I2C, CAN, USB, or any other suitable connection). The set of modules 102 comprises individual expansion modules 104, each of which can be connected to any desired laboratory equipment. The universal controller processor 106 comprises either a multitasking (e.g., MicroC/OS-II) or a non-multitasking (e.g., a looped state machine) operating system firmware 108, which receives external control bytecodes via a TCP/IP server 110, processes same into machine-understandable instructions, and dispatches same to the universal controller expansion modules 104 for execution. Further, the operating system firmware 108 operates in an SPI master mode, gathering results from the expansion modules 104 and transmitting same over a network via TCP/IP server 110.

A compiler, such as Dynamic C or other suitable compiler, generates the code for the operating system firmware 108, which supports the full TCP/IP protocol stack used for communication over the Ethernet interface. The SPI protocol is used to communicate with the individual expansion modules.

The resource manager 112 comprises a TCP client thread 114, which is responsible for dispatching bytecodes to and from the universal controller processor 106. A main program 116 provides functionality, discussed later, for processing and dispatching commands and data, as well as for providing a library of instructions. A TCP server thread 118 allows for external communication between a user client application 124 and the resource manager 112. An HTTP web server 120 interacts with an external web browser 130, and provides a user interface for allowing a user to interact with the remote sensors and actuators. An SQL database 122 stores and manages commands and data dispatched by the resource manager 112, as well as scheduled processes and tasks.

A user client application 124 provides the user with an interface for interacting with one or more external sensors and/or actuators. A MATLAB or EXCEL utility 126 allows a student to perform post-processing of data received from the sensors and/or actuators. A JAVA applet 128 allows the user to submit requests or commands, and to retrieve and review data from the sensors and actuators, as well as status information. A web browser 130 allows the user to log in, register with, and utilize the present invention.

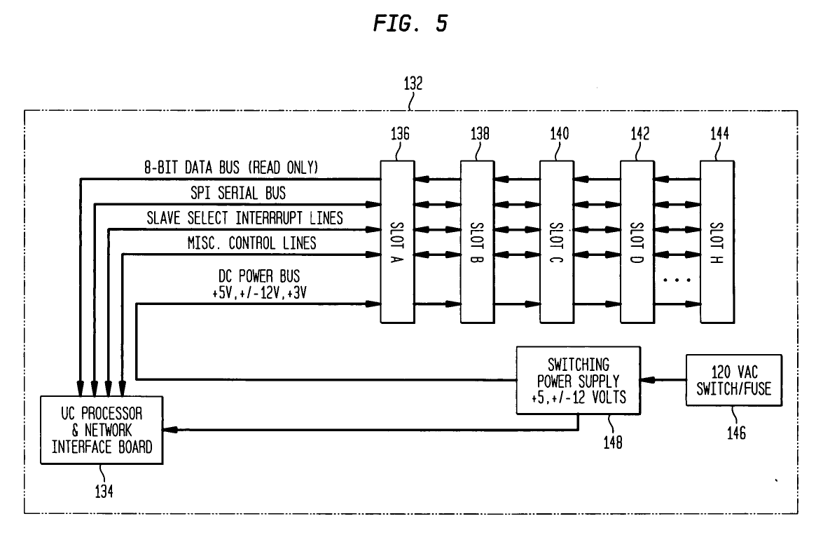

FIG. 5 is a block diagram showing an embodiment of the universal controller and expansion module of the present invention, indicated generally at 132. The universal controller and expansion module 132 comprises a universal controller processor and network interface board 134, powered by a switching power supply 148 connected to a 120 VAC power source 146. A plurality of expansion module slots 136-144 are provided, and allow a multitude of non-homogenous sensors and actuators to be connected therewith. The slots 136-144 communicate with the board 134 via a plurality of data buses, including an 8-bit data bus, an SPI serial bus, slave select/interrupt lines, and miscellaneous control lines. Power is provided from the power supply 148 to the slots 136-144.

The power supply unit 148 can be any commercial, off-the-shelf device capable of producing power of at least 60 Watts, with regulated outputs of +/−5 and +/−12 VDC. The board 134 is preferably a custom-designed back plane housing eight of the slots 136-144, but of course, any number of slots could be provided. A RABBIT SEMICONDUCTOR RM2100 processor module having an integrated memory and an Ethernet interface preferably controls the flow of data between the individual expansion modules and the resource manager of the present invention. The RM2100 includes an on-board SRAM of 512 Kb, an available flash memory program storage of 512 Kb, and a processor clock of 22.1 MHz.

FIG. 6 is a block diagram showing processing sequences for handling instructions generated by a user and results generated by an access device. Sequence 150 receives commands initiated by a user, processes same, and dispatches same to an external device for execution. In step 152, a user enters instructions for a remote device, or selects from a library of instructions. The high-level instructions are transferred to step 154, wherein an instruction compiler converts the instructions into bytecodes. The bytecodes are then transmitted to a resource manager, which routes the bytecode sequence to a selected universal controller. In step 158, the universal controller receives the bytecodes, and decodes same into bytecode packets. The bytecode packets are forwarded in step 160 to an expansion module, where they are then decoded into one or more voltage signals. The voltage signals are then sent in step 162 to one or more of a combination of actuators and sensors to activate same.

Sequence 170 receives results of execution from one or more remote sensors and actuators, then processes and dispatches same for display to a user. Beginning in step 172, the results from the sensor are received as voltage signals, and transmitted to an expansion module in step 174. The expansion module reads and decodes the voltage signals, and constructs a stream of raw data that is sent to the CPU. In step 176, the CPU converts and/or formats the raw data stream for transmission over a network. The processed raw data stream is then transmitted by the CPU, and received in a results queue of the resource manager of the present invention in step 178. Then, the results are routed back to the user interface in step 180. In step 182, the user face receives the results, and formats same for display to the user (preferably as one or more HTML pages viewable within a web browser).

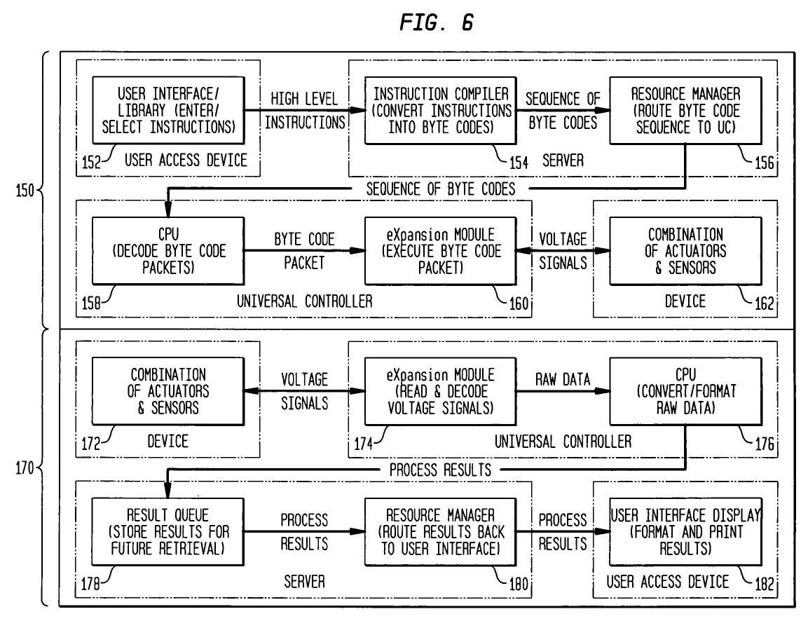

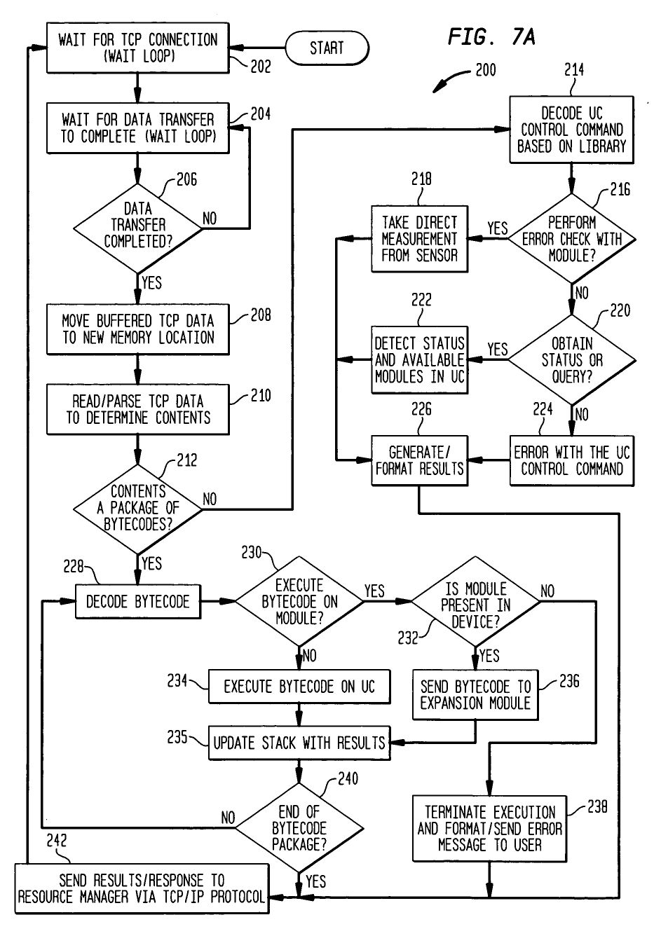

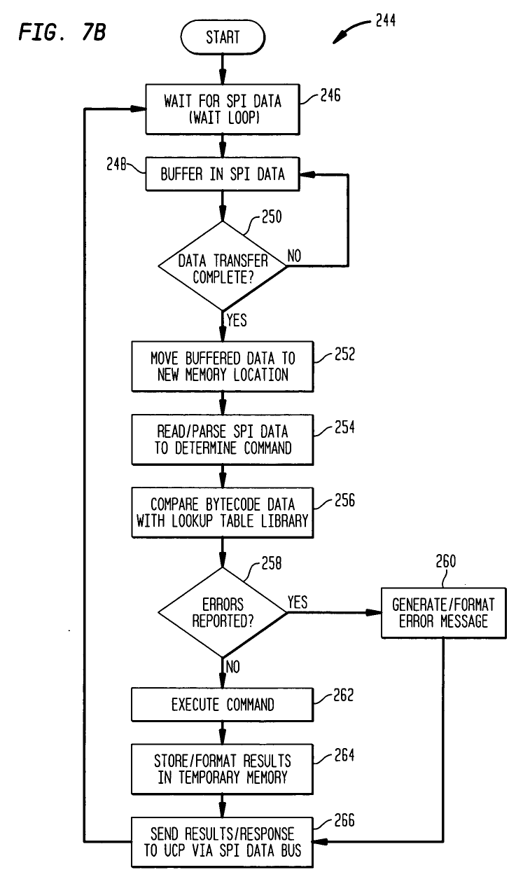

FIG. 7a is a flowchart showing processing logic of the universal controller of the present invention, indicated generally at 200. Beginning in step 202, the universal controller waits for a TCP connection. In step 204, once a TCP connection has been initiated, the universal controller waits until all data has been transferred from an external source. If data transfer has been determined in step 206 not to be complete, step 204 is re-invoked, so that all data is received. Otherwise, step 208 is invoked.

In step 208, buffered TCP data is moved to a new memory location within the universal controller. Then, in step 210, the TCP data is read and parsed to determine its contents. In step 212, a determination is made as to whether the contents correspond to a package of bytecodes. If a positive determination is made, step 228 is invoked, wherein the package of bytecodes are decoded. Then, in step 230, a determination is made as to whether to execute the bytecode on a specific module. If a positive determination is made, step 232 is invoked, wherein a determination is made as to whether the module is present (e.g., connected to the universal controller). If a negative determination is made, step 238 is invoked, wherein execution is terminated and an error message is generated and sent to the user. If a positive determination is made, step 236 is invoked, wherein the bytecode is sent to the module and executed thereby. Then, in step 235, the results of execution are gathered and stored in a stack. In step 240, a determination is made as to whether the end of the bytecode package has been reached. If a negative determination is made, step 228 is re-invoked, so that additional bytecodes can be decoded and processed; otherwise, step 242 is invoked, wherein the results of processing are gathered and sent to the resource manager via the TCP/IP protocol.

In the event that a negative determination is made by step 230, step 234 is invoked. In step 234, the bytecode is executed by the universal controller. An example of such a bytecode is a request for status information relating to the universal controller. Then, step 235 is invoked, wherein the stack is updated with results of execution. Step 240, discussed earlier, is then invoked, wherein a determination is made as to whether additional bytecodes exist. If a positive determination is made, step 228 is re-invoked, so that the additional bytecodes can be processed. Otherwise, step 242 is invoked, wherein results of execution are gathered and sent to the resource manager via the TCP/IP protocol.

In the event that a negative determination is made in step 212 (the contents of the data package are not bytecodes), step 214 is invoked. At this point, the data package is determined to correspond to a control command for the universal controller, and the command is decoded based upon a pre-determined library of control commands. In step 216, a determination is made as to whether to perform an error check on one or more modules connected to the universal controller. If a positive determination is made, step 218 is invoked, wherein a direct measurement is taken from a sensor connected to the controller. Then, in step 226, results are generated and formatted. Step 242 is then invoked, so that the results can be sent to the resource manager.

In the event that a negative determination is made in step 216, step 220 is invoked, wherein a second determination is made as to whether to perform a query to obtain status information. If a positive determination is made, step 222 is invoked, wherein the status of universal controller or one or more devices connected therewith is ascertained. The results of the status query are gathered in step 226, and then transferred to step 242, wherein the results are dispatched to the resource manager. If a negative determination is made in step 220, step 224 is invoked, wherein an error condition with the universal controller is determined to have occurred. In this case, step 226 is invoked, wherein an error message is generated. The message is then sent to step 242, wherein it is dispatched to the resource manager.

FIG. 7b is a flowchart showing processing logic of the expansion module of the present invention, indicated generally at 244. Beginning in step 246 the expansion module waits for data generated by the universal controller and transmitted over the SPI data bus. Then, in step 248, if an SPI connection is made, the data is buffered by the expansion module. In step 250, a determination is made as to whether data transfer is complete. If not, step 248 is re-invoked, so that additional data can be buffered. Otherwise, step 252 is invoked.

In step 252, the buffered data is moved to a new memory location within the expansion module. Then, in step 254, the data is read and parsed to determine whether a command is present therein. In step 256, the bytecode data is compared with a lookup table. A determination is made in step 258 as to whether any errors have been reported. If a positive determination is made, step 260 is invoked, wherein an error message is generated and formatted. The error message is then passed to step 266, wherein the message is sent to the universal controller processor via the SPI data bus.

If a negative determination is made in step 258, step 262 is invoked, wherein the command is executed. The executed command results in the activation of one or more sensors or actuators connected to the expansion module. After execution, step 264 is invoked, wherein results from the sensors or actuators are gathered, and stored in temporary memory. Then, the results are passed to step 266, wherein they are transferred to the universal controller processor via the SPI data bus.

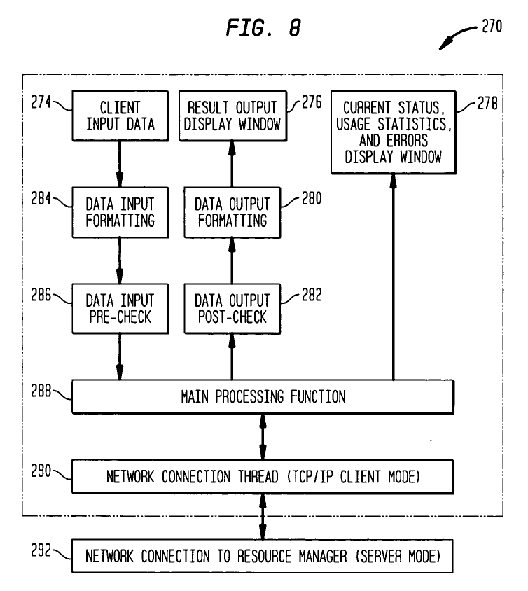

FIG. 8 is a block diagram showing component parts of the user interface of the present invention, indicated generally at 270. The user interface of the present invention can be generated using any suitable programming language known in the art, such as C, C++, JAVA, or other language. As mentioned previously, the user interface of the present invention allows a user to enter high-level instructions, or to select one or more pre-defined instructions from a library and execute same, via an interface at a user access device. Instructions entered via the interface are checked thereby for errors, and sent to the resource manager of the present invention via a known network protocol, such as the TCP/IP protocol. Such instructions include, but are not limited to, requests for status information from one or more resource managers, or a series of high-level instructions for execution by a sensor or actuator connected to a universal controller.

The software architecture 270 of the user interface comprises two main components, a processing component 272 and a resource manager network connection 292. The processing component 272 primarily handles user input and output. In block 274, a user can input data, such as the aforementioned high-level instructions. In block 284, the input data is formatted into a common format. Then, in block 286, a preliminary check of the inputted data is performed to verify that the data conforms to pre-determined standards. In block 288, a main processing function is provided, and handles both user input and user output.

When the high-level instructions have been checked, formatted, and processed, they are passed to network connection thread 240. The network connection thread 240 operates as a TCP/IP client, and transmits the instructions as TCP/IP packets that are received by the network connection 292 of the resource manager. After the instructions have been either processed directly by the resource manager, or dispatched to and processed by one or more of the universal controllers of the present invention, responsive information is generated and gathered by the resource manager. Thereupon, the responsive information is transmitted from the resource manager via the network connection 292, for receipt by the network connection thread 290.

Response information received by the network connection thread 290 is transmitted to the main processing function 288, discussed earlier, for processing. If the responsive information comprises status information, the information is displayed in a window 278. Examples of status information displayable in window 278 include current device status, usage statistics, and error reporting. Other types of responsive information, including results of execution of instructions by one or more universal controllers and devices connected thereto, are sent by the main processing function 288 to the data output post-check module 282. This module ensures that the results of execution conform to pre-determined standards. Once checked, the results are sent to a data output formatting module 280 for formatting into a standard format, such as HTML or XML. The results are then displayed in the user interface via output display window 276.

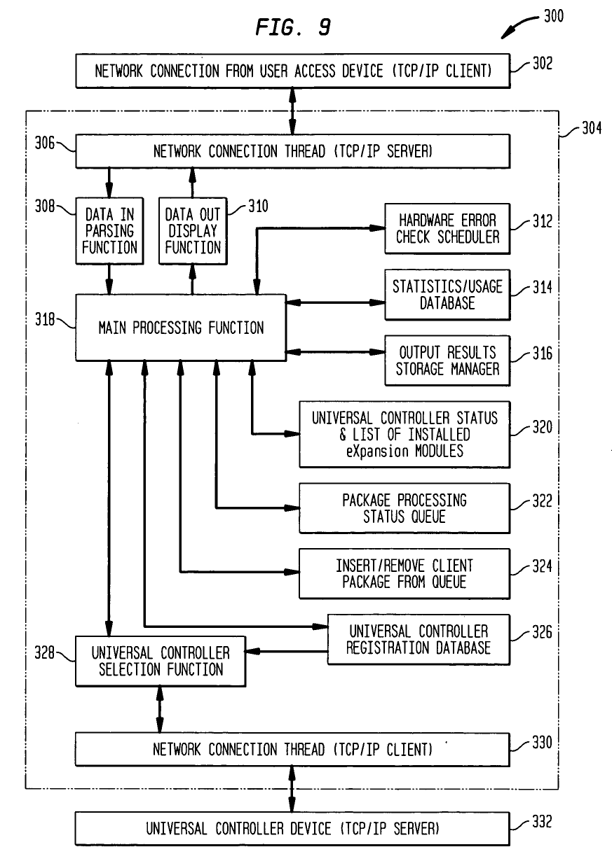

FIG. 9 is a block diagram showing processing logic of the resource manager of the present invention, indicated generally at 300. A plurality of software components 304 receive instructions from the user access device via a first network connection 302, process same, and dispatch the instructions to one or more universal controllers via a second network connection 332. Further, the software components 304 receive responsive data from the one or more universal controllers via the second network connection 332, process same, and dispatch the responsive data to the user access device via the first network connection 302. The first and second network connections 302 and 332 are preferably based on the TCP/IP standard, but of course, any networking protocol could be implemented without departing from the spirit or scope of the present invention. Further, a single network connection could be provided for allowing the resource manager to communicate with a network, and various network threads created for handling input and output data streams received from and transmitted via the single network connection.

The plurality of software components 304 comprise a number of modules that operate together to provide the functionality of the resource manager of the present invention. A first network connection thread 306, operating in a TCP/IP server mode, receives commands from and dispatches data to the first network connection 302. A second network connection thread 330, operating in a TCP/IP client mode, dispatches commands to and receives responsive data from the second network connection 332.

An incoming data parsing function 308 parses commands received by the network connection thread 306, and determines the type of command. Once parsed, the command is then passed to main processing function 318. An outgoing data display function 310 prints results received from one or more universal controllers and processed by the main processing function 318. Once processed, the results are then sent from the display function 310 to the first network connection thread 306, for transmission to the user access device via the first network connection 302.

The main processing function 318 performs a number of functions, and interacts with modules 312, 314, 316, 320, 322, 324, 326, and 328. Module 312 provides hardware checking and scheduling functionality, and manages hardware errors generated by one or more devices connected to the present invention. Module 314 comprises a statistics/usage database for tracking system usage information. Module 316 stores and manages output results. Module 320 comprises a storage means (such as a list, table, database, or other suitable storage means) for storing status information and a list of installed expansion modules of one or more universal controllers. Module 322 comprises a storage means (such as a list, table, database, or other suitable storage means) for storing status information relating to package processing. Module 324 comprises a procedure for inserting or removing client packages from a queue.

Module 326 comprises a registration database for tracking IP addresses and DNS names of one or more of the universal controllers of the present invention. This allows the resource manager to quickly locate a specific universal controller, using either its IP address or DNS name. Module 328 comprises a universal controller selection function for selecting one or more universal controllers in response to instructions received via the first network connection 302.

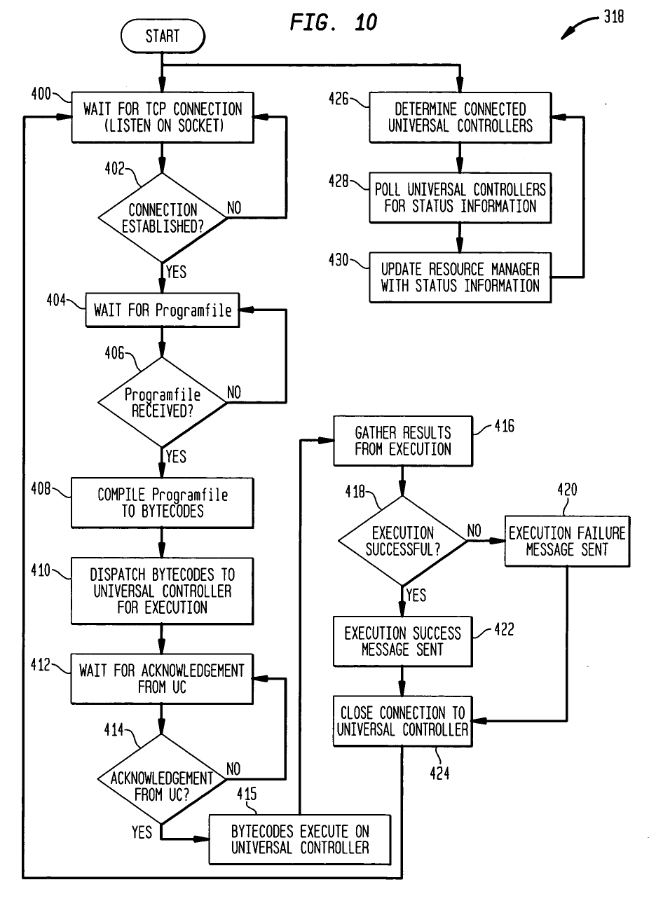

FIG. 10 is a flowchart showing additional processing logic of the resource manager of the present invention, indicated generally at 318. Beginning in step 400, the resource manager waits for a TCP connection from the user interface (e.g., from one or more user access devices). In step 402, a determination is made as to whether a connection has been made. If a negative determination is made, step 400 is re-invoked; otherwise, step 404 is invoked, wherein the resource manager waits to receive a program file (e.g., one or more high-level instructions for execution by one or more universal controllers or devices connected thereto) from the user interface. In step 406, a determination is made as to whether the program file transmission is completed. If a negative determination is made, step 404 is re-invoked, and the resource manager waits for a program file; otherwise, step 408 is invoked. In step 408, the program file is passed to a compiler and compiled into bytecodes.

In step 410, the bytecodes are dispatched to one or more of the universal controllers and executed. In step 412, the resource manager waits for an acknowledgment message from the universal controller that all bytecodes have been received successfully. In step 414, a determination is made as to whether the acknowledgment was received. If a negative determination is made, step 412 is re-invoked and the resource manager continues to wait until a timeout or error message is encountered; otherwise, the universal controller begins to execute the bytecodes in step 415. Step 416 is then invoked, wherein the results of execution are gathered from the universal controller and stored within the resource manager. In step 418, a determination is made as to whether the execution is successful. If a negative determination is made, an execution failure message is sent by the universal controller to the resource manager in step 420; otherwise an execution success message is sent by the universal controller to the resource manager in step 422. Then, the connection is closed in step 424. Step 400 is then re-invoked so that additional data from the user interface can be processed.

The processing logic 318 also includes a loop, defined by steps 426, 428, and 430, for updating status information pertaining to the universal controllers and the devices connected thereto. In step 426, connected universal controllers are ascertained. In step 428, the universal controllers are polled for status information. In step 430, the resource manager is updated with the status information. Such information can be stored in, for example, a table or database residing on the resource manager. Step 426 is then re-invoked, so that additional universal controller status information can be acquired. In this arrangement, the resource manager is continually updated with status information pertaining to the universal controllers and the devices connected thereto, thus enabling the resource manager to quickly determine the presence and availabilities of universal controllers in the system, as well as the presences, types, and availabilities of sensors, actuators, and devices connected therewith.

FIG. 11a is a block diagram showing additional processing logic of the compiler of the present invention, indicated generally at 340. As was previously mentioned, the present invention allows a user to remotely enter high-level instructions for remotely controlling and monitoring a plurality of sensors and actuators. In a preferred embodiment of the present invention, such instructions are entered in a high-level computing language that can be implemented on any computing system. The high-level instructions are compiled into low-level bytecodes that are understandable by the universal controller of the present invention and executed thereby to activate one or more sensors, controller, or actuators therewith.

Beginning with step 342, user source code is read from a file. The file contains one or more of the aforementioned high-level instructions that have been entered by the user via the user interface. In step 344, the user source code is passed through a lexer, which generates tokens 345. In step 346, the tokens are passed through a parser to determine their integrity and compliance with pre-determined standards (e.g., bad input formats or corrupt data are sensed for). After step 346, optional optimizing functions for generating more efficient bytecodes can be introduced in step 347. Then, in step 348, an abstract syntax tree is generated, which is passed through a type checker in step 349, resulting in an abstract syntax tree with types 350. In step 351, the code generator generates the machine code 352. In step 353, an optional peephole optimizer can be introduced to generate optimized machine code 354. In step 355, the non-optimized or optimized machine code is passed through an omitter, which generates the final machine bytecodes that are written to a file in step 356.

FIG. 11b is a diagram showing compilation of a series of high-level instructions into bytecodes executable by the universal controller of the present invention. A high-level program is shown in the left-most block, and can be provided from the user interface of the present invention. The high-level program can include a variety of high-level function calls for activating one or more remote sensors, actuators, or devices connected to one or more universal controllers. For example, the “read_adc” function shown in the high-level program listed in FIG. 11b allows the user to read information from an analog-to-digital controller connected to a universal controller. The function is provided with the address of the analog-to-digital controller via the “ADC_ADDR” variable, and a sampling channel is specified by the “CHI” variable. Any conceivable function type for any conceivable device can be provided.

The high-level program shown in FIG. 11b is compiled into a series of low-level instructions, shown in the center listing of FIG. 11b. The low-level instructions are similar to hardware-level assembly language instructions. The low-level instructions are then converted into the bytecodes that appear in the right-most listing of FIG. 11b. The bytecodes are then dispatched to one or more universal controllers, for execution by the universal controller or one or more devices connected thereto.

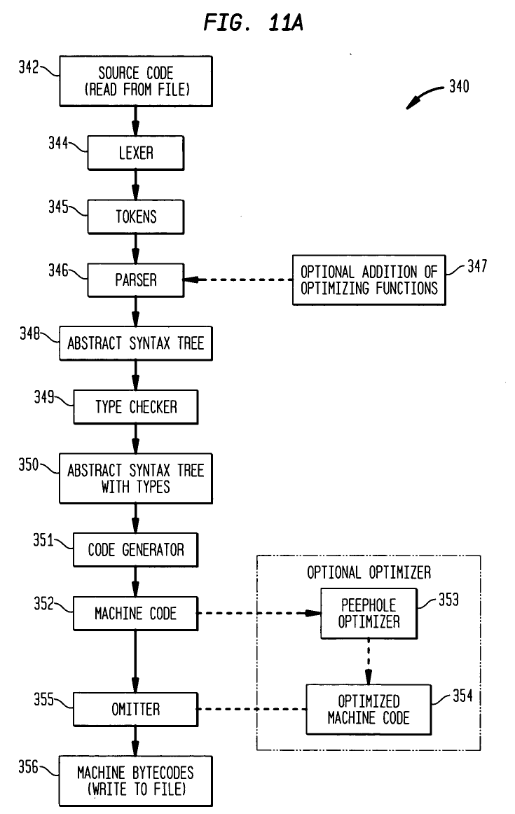

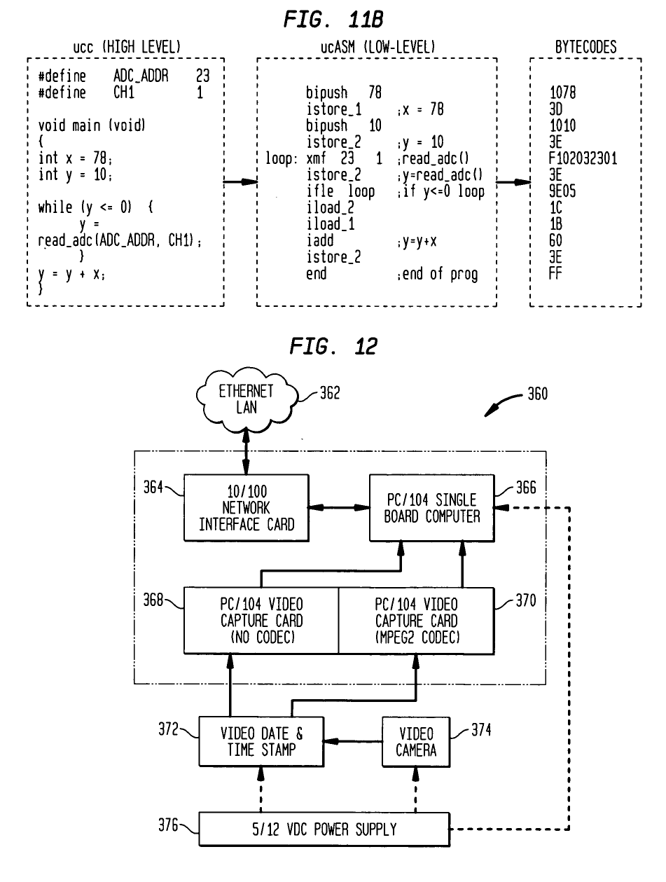

FIG. 12 is a block diagram showing a video capture device in accordance with the present invention, indicated generally at 360. As mentioned previously, the present invention is adaptable to allow devices of various types to be remotely controlled and accessed. In one embodiment of the present invention, remote video devices can be remotely controlled and accessed. Thus, as shown in FIG. 12, a video camera 374 is provided for allowing still images or full-motion video at a remote location to be captured and accessed remotely. The video camera 374 could be any video camera known in the art. Output from the video camera is sent to a video date and time stamp module 372, which applies a date and time stamp to the captured video.

Once date and time stamped, the video stream is sent to two video capture cards 368 and 370. The first video capture card 368 converts the video stream to a flat binary stream, using no compression or CODEC (encoder/decoder). The second video capture card 370 preferably includes an MPEG-2 video CODEC, and compresses the video stream into an MPEG-2 compatible video stream. Outputs of the two video capture cards 368 and 370 are then sent to a single board computer 366, which allows the compressed and uncompressed video streams to be accessible via a network 362 via an Ethernet interface card 364. A 5 or 12 VDC power supply 376 provides power to each of the components. The video capture system shown in FIG. 11 can be accessed by a user via the user interface of the present invention, and controlled remotely thereby. Further, the video capture system can be integrated with the resource manager of the present invention, allowing multiple video capture systems to be accessed and controlled. Additionally, the video capture device 360 could be altered to include only a single video capture card, providing either compressed or uncompressed streaming video.

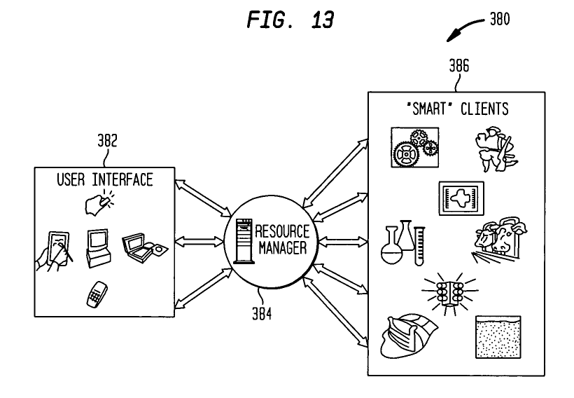

FIG. 13 is a diagram, indicated generally at 380, showing interactions between the user interface and resource manager of the present invention, and one or more smart clients. The present invention allows a variety of disparate devices in a multitude of different environments to be remotely accessed and controlled. A plurality of user interface devices 382 could be provided, such as PDAs, desktop computers, wireless devices (e.g., cell phones, pagers), and other similar devices, for allowing the user to remotely access and control smart clients 386. The smart clients could comprise sensors, controller, and actuators in medical, manufacturing, laboratory, traffic control, agricultural, and other environments. Preferably, the smart clients each include one or more universal controllers according to the present invention for integrating a variety of disparate sensors, actuators, and controllers. The resource manager 384 handles interactions between the user interface devices 382 and smart clients 386.

FIGS. 14-19 are block diagrams showing various packet structures according to the present invention. The packet structures follow a common format, and allow the universal controller of the present invention to perform control and monitoring functions on each of the devices connected thereto.

FIG. 14 is a block diagram showing a packet structure for transmitting control commands to a module. This packet is used for specifying actual commands to be executed by the universal controllers. A header field is provided for specifying that the packet is a command packet. An expansion module address field is provided for specifying an address of an expansion module of desired universal controller, to which the packet should be sent. An opcode command field contains a machine-understandable instruction that is executed by the expansion module and causes one or more sensors or actuators connected therewith to be activated. A plurality of data fields are also provide for transmitting parameter information that is to be executed with the opcode. For example, an opcode could be executed for activating a relay connected to the expansion module, for a duration of time specified in one or more of the data fields. Any conceivable command and associated parameters could be included in the command packet structure.

FIG. 15 is a block diagram showing a packet structure according to the present invention for transmitting an event from a module. This packet is used for indicating to the universal controller that a given event has occurred. A header field is provided for specifying that the packet is an event packet. An event type field is provided for specifying the type of event that has occurred. An opcode command field contains a machine-understandable instruction corresponding to the event. A plurality of data fields are also provide for transmitting parameter information corresponding to the event.

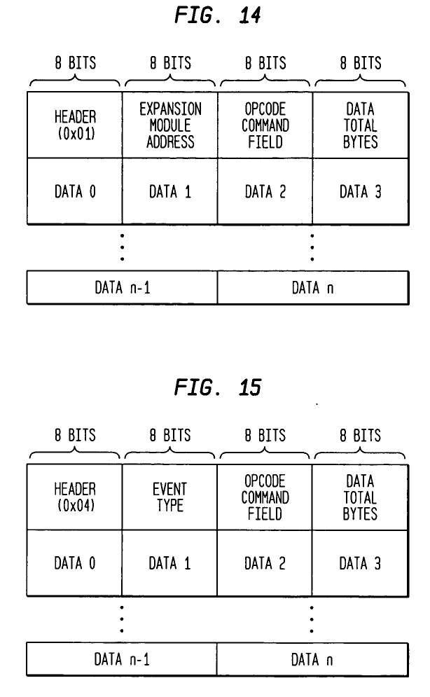

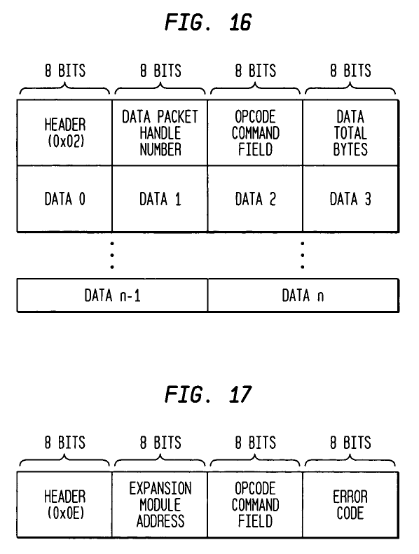

FIG. 16 is a block diagram showing a packet structure according to the present invention for transmitting data between the universal controller of the present invention and an expansion module. Data is transmitted to the universal controller using this packet structure. A header field is provided for specifying that the packet is a data packet. An expansion module address field is provided for indicating the address of the module from which the results were generated. An opcode command field is provided, and contains a machine-understandable code corresponding to the transmitted data. A plurality of data fields are provided for transmitting the results data. For example, these fields could contain temperature information resulting from the actuation of a temperature measurement module, or light level information resulting from the actuation of a photometer. Any conceivable type of data corresponding to any type of information could be stored and transmitted using the data packet structure.

FIG. 17 is a block diagram showing a packet structure according to the present invention for transmitting error codes. In the event that an error is generated by one or more devices connected to the universal controller of the present invention (e.g., the device is physically disconnected from the universal controller, or is malfunctioning), an error code is generated and transmitted using the error packet structure. A header field is provided for indicating that the packet is an error packet. An expansion module address field is provided for indicating the address of the expansion module where the error has been detected. An opcode command field is provided, and contains a machine-understandable command corresponding to the detected error. An error code field is provided, and contains information about the error, such as type of error, duration of error condition, etc.

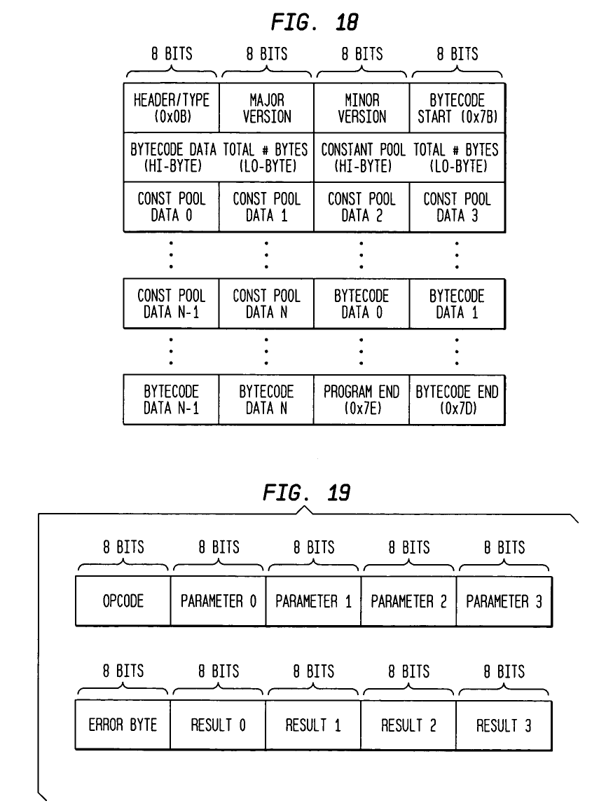

FIG. 18 is a block diagram showing a packet structure for transmitting data between the resource manager of the present invention and one or more universal controllers. This packet structure consists of a packet type header, a bytecode version, fields containing the number of bytes of the bytecode payload, the number of bytes of the constant pool, constant pool data, bytecode data, and an end code.

FIG. 19 is a block diagram showing another packet structure for transmitting data between the universal controller of the present invention and an expansion module. For transferring data from the universal controller to an expansion module, a single-byte opcode is sent, followed by up to four bytes of parameters. For transferring data from the expansion module to the universal controller, a single-byte error code is sent, followed by up to four bytes of data representing results of the execution of the opcode by the expansion module.

In conclusion, the present invention provides a multi-user, multi-device remote access system for allowing a user to remotely access and control a wide variety of devices, including sensors, actuators, controllers, servers, access points, video devices, and other similar devices. The devices are managed by a resource manager that provides status information and selectively dispatches commands generated at the user interface to one or more remote devices. A plurality of universal controllers allows devices of various types to be connected therewith, and dynamically integrated for use with the present invention. The invention can be implemented in any environment where remote access and monitoring of various, spatially-distributed devices is desired.

Having thus described the invention in detail, it is to be understood that the foregoing description is not intended to limit the spirit and scope thereof. What is desired to be protected by Letters Patent is set forth in the appended claims.

1. A remote access system comprising:
a user interface for entering a high-level instruction for controlling a remote device;
a plurality of remote devices;
one or more universal controllers connected to the plurality of remote devices; and
a resource manager connected to the one or more universal controllers, the resource manager monitoring system status information, receiving the high-level instruction from the user interface, compiling the high-level instruction into one or more bytecodes, identifying an appropriate universal controller, and automatically dispatching the bytecodes to a universal controller for execution thereby, the bytecodes controlling one or more of the plurality of remote devices.

2. The system of claim 1, wherein the plurality of remote devices comprises sensors.

3. The system of claim 2, wherein the sensors comprise electromechanical, optical, acoustic, seismic, magnetic, moisture, pollution, organic, pressure, acceleration, physiological, or thermal sensors.

4. The system of claim 1, wherein the plurality of remote devices comprises actuators.

5. The system of claim 4, wherein the actuators comprise electric motors, pneumatic drives, hydraulic drives, electromagnetic drives, pumps, valves, fans, relays, or switches.

6. The system of claim 1, further comprising a multiplexer for connecting the plurality of remote devices to the universal controller.

7. The system of claim 6, wherein the multiplexer allows for switching between analog and digital devices.

8. The system of claim 1, wherein the one or more universal controllers automatically detect and integrate additional devices connected thereto.

9. The system of claim 8, wherein the one or more universal controllers automatically provide status information about the additional devices to the resource manager.

10. The system of claim 1, further comprising a computer program written at the user interface, the computer program including a plurality of high-level instructions for controlling one or more of the plurality of remote devices.

11. The system of claim 1, wherein the resource manager further comprises a library of high-level instructions.

12. The system of claim 11, wherein the library is accessible via the user interface.

13. The system of claim 12, wherein the user can select a high-level instruction from the library for execution by the one or more universal controllers.

14. The system of claim 1, wherein the one or more universal controllers provides status information and results of execution to the resource manager.

15. The system of claim 1, wherein the one or more universal controllers further comprise a plurality of expansion modules.

16. The system of claim 15, wherein the expansion modules are connected to the plurality of devices.

17. The system of claim 16, wherein the expansion modules provide up/down counting, digital inputting/outputting, analog to digital conversion, digital to analog conversion, signal generation, power amplification, or opto-relay switching.

18. The system of claim 1, wherein the universal controller executes loops of instructions.

19. The system of claim 1, wherein the universal controller executes mathematical computations.

20. The system of claim 1, wherein the universal controller stores to and reads from local and remote memory.

21. A method for allowing a user to remotely access a plurality of remote devices comprising:
allowing the user to enter a high-level instruction at a user interface;
receiving the high-level instructions at a resource manager;
compiling the high-level instruction into a plurality of bytecodes;
choosing a universal controller connected to the resource manager based upon system status information;
automatically dispatching the bytecodes to the universal controller based upon the instruction and status information corresponding to the universal controller; and
executing the bytecodes to activate one or more of the plurality of remote devices.

22. The method of claim 21, further comprising:
gathering results of execution at the universal controller;
transmitting the results to the resource manager; and
dispatching the results to the user interface for review by the user.

23. The method of claim 21, wherein the step of executing the bytecodes comprises activating a sensor in response to the bytecodes.

24. The method of claim 23, further comprising activating electromechanical, optical, acoustic, seismic, magnetic, moisture, pollution, organic, pressure, acceleration, physiological, or thermal sensors in response to the bytecodes.

25. The method of claim 21, wherein the step of executing the bytecodes comprises activating an actuator in response to the bytecodes.

26. The method of claim 25, further comprising activating electric motors, pneumatic drives, hydraulic drives, electromagnetic drives, pumps, valves, fans, relays, or switches in response to the bytecodes.

27. The method of claim 21, further comprising connecting additional remote devices to the universal controller.

28. The method of claim 27, further comprising automatically detecting device types and integrating the additional remote devices.

29. The method of claim 28, further comprising automatically dispatching status information about the additional devices to the resource manager.

30. The method of claim 21, further comprising providing a library of high-level instructions accessible via the user interface.

31. The method of claim 30, further comprising allowing the user to select an instruction from the library of high-level instructions.

32. The method of claim 31, further comprising compiling, dispatching, and executing the instruction.

34. The method of claim 21, further comprising dispatching unrecognized bytecodes from the universal controller to one or more expansion modules connected to the universal controller.

35. The method of claim 34, further comprising executing the unrecognized bytecodes at the one or more expansion modules.
